(19) United States
(12) Patent Application Publication
(10) Pub. No.: US 2024/0285465 A1
(43) Pub. Date: Aug. 29, 2024

(54) METHODS AND APPARATUS FOR ATTACHMENT TO A USER'S EXTERIOR SURFACE

(71) Applicant: Daily Products, Inc., Los Angeles, CA (US)

(72) Inventor: Michael David Daily, Los Angeles, CA (US)

(21) Appl. No.: 18/115,259

(22) Filed: Feb. 28, 2023

(51) Int. Cl. A61H 7/00

(52) U.S. Cl. CPC A61H 7/003; A61H 2201/1654; A61H 2201/1692; A61H 2205/102

(57) ABSTRACT

A patch can be configured for nonpermanent attachment to an exterior surface of a user wherein tissue can be disposed beneath the exterior surface. The patch can include a base defining opposing substantially planar surfaces, the substantially planar surfaces including a user engaging surface and an opposite surface. The user engaging surface can include an adhesive configured for non-permanent attachment to the user's exterior surface. The adhesive can be being configured to form a sufficiently strong bond with the user's exterior surface such that movement of the base causes movement of the tissue beneath the user's exterior surface. A handle can project from the opposite surface of the base in a direction away from the user engaging surface, the handle communicating with the base such that movement of the handle causes movement of the base.

### BACKGROUND

Some embodiments are directed toward methods and apparatus for attachment to a user's exterior surface. Specifically, some of the embodiments relate to a patch that can attach to a user's skin, particularly scar tissue, such as for easy manipulation of such scar tissue.

Surgery can require cutting of the skin to reveal underlying tissues on which medical intervention can be required. Some surgeries result in some level of bruising and/or scarring, both of which can result in limited tissue mobility on and around the scar tissue thus formed. The scar tissue may negatively affect the arterial circulation, lymph circulation, fascial mobility, muscle contractibility, and joint range of motion, which in turn affect a patient's range of motion and strength, in some cases resulting in a permanent loss of normal functional mobility.

For example, one such type of surgery is knee replacement. During a total or partial knee replacement or revision, an incision is made in a knee portion of a leg of the patient to obtain access to the knee joint. The incision is relatively long to enable instrumentation, such as a femoral alignment guide, anterior resection guide, distal resection guide, femoral cutting guide, and femoral anterior, posterior and chamfer resection guide to be positioned relative to a distal end portion of the femur. In addition, the incision can be relatively large to enable a tibial resection guide to be positioned relative to the proximal end portion of the tibia.

Knee surgery is estimated to be performed about 800,000 times annually in the United States alone. Following this procedure, there is a significant scar on the front of the knee measuring anywhere from 6 to 10 inches long that penetrates deeply, in some cases, to the bone.

### SUMMARY

Scarring can affect the patient's ability to bend the knee. Thus, it may be advantageous to address such scarring and/or mobility and other issues caused directly or indirectly from such scarring. However, embodiments are intended to also be directed toward other issues.

Mobilization of a scar can be performed manually either by a clinician or the individual. This can be done by hand or a method such as cupping to lift the scar tissue up and away from the body. However, a method such as cupping can require having the proper cupping equipment, lotion, and clinical skill. Further, if scar mobilization is too aggressive it can be painful and add to the development of further scar tissue. As is also known in the art, an adhesive tape can be used to allow a patient to mobilize the scar tissue in order to soften the scar and restore mobility. However, these adhesives may not be long lasting and frequently lose their adhesive qualities within a short time. These adhesive tapes can be prone to disengaging from the patient. Application of such adhesive tapes can be a complex process that cannot be readily done by the patient themselves. Thus, scar tissue mobilization may not be effectively performed by the patients when away from a clinician. This leads to longer recovery times, less mobility, and additional pain during physical therapy.

Some embodiments disclosed herein are directed to a patch configured for nonpermanent attachment to an exterior surface of a user (e.g., skin). Disposed beneath the exterior surface of the user is a tissue surface contemplated to include at least some scar tissue. The patch includes a base and a handle.

The base can be defined by two opposing planer surfaces. One such planer surface is a user engaging surface, and the other planer surface is disposed opposite the user engaging surface. It is contemplated that the base can be formed as a circular cross section. With respect to the user engaging surface, an adhesive is included. A non-permanent attachment to the user's exterior surface may be provided by the adhesive. It is also contemplated that the adhesive can form a sufficiently strong bond with the user's exterior surface so that the movement of the base causes movement of the tissue beneath the user's exterior surface. Possibly, this sufficiently strong bond can provide for myofascial release, for example by movement of a handle that causes the base to move.

Some embodiments can include a handle that projects from the opposite surface of the base in a direction away from the user engaging surface and allows for communication with the base such that the movement of the handle also causes movement of the base. In an embodiment, the handle may be configured to be moveable via manual manipulation, for example in the x, y, and z directions. The handle can include a first handle member defined as a cross section having a linear bottom that is configured for attachment to the base. The first handle member may also be further defined as a cross section having an arcuate top that extends furthest from the opposite surface of the base (e.g., having a semi-circular cross section). The handle can also have a second handle member having similar characteristics of the first handle members. The handle members can each be further defined as having a sinusoidal cross section. Each handle member can further be integrally attached to the other, disposed at right angles relative to the other, both handle members unitarily formed, or combinations thereof.

In some embodiments a cover can be included in the patch. The cover may be placed over at least a portion of the engaging surface of the base that includes the adhesive. A second cover may also be included so that the cover and the second cover together may be both placed over the engaging surface of the patch, thereby covering a surface of the patch.

A variety of compositions and formations are contemplated. For example, the base, handle, or combination thereof can be formed of non-woven polyester. The base could be formed of a material that is hypoallergenic, waterproof, semipermeable, or any combination thereof. The base and the handle may also be formed unitarily. It is also contemplated that the base and the handle are attached via adhesive, or by a mechanical attachment.

### BRIEF DESCRIPTION OF THE DRAWINGS

The disclosed subject matter of the present application will now be described in more detail with reference to exemplary embodiments of the apparatus, given by way of example, and with reference to the accompanying drawings, in which:

FIG. 1A illustrates a front isometric view of the patch in accordance with one embodiment.

FIG. 1B illustrates a rear isometric view of the patch in accordance with one embodiment.

FIG. 2 illustrates a top view of the patch in accordance with one embodiment.

FIG. 3 illustrates a cross-sectional view of the patch in accordance with one embodiment.

FIG. 4 illustrates an isometric top view of the covers in an interlocked configuration in accordance with one embodiment.

FIG. 5 illustrates an isometric top view of the covers in a separated configuration in accordance with one embodiment.

FIG. 6 illustrates a cross-sectional partial view of the base and covers in accordance with one embodiment.

FIG. 7 illustrates a cross-sectional view of the patch attached to the exterior surface of the user in accordance with one embodiment.

FIG. 8 illustrates another cross-sectional partial view of the patch attached to the exterior surface of the user as shown in FIG. 7.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

Currently, there is a need felt in the art for an adhesive product to improve scar mobility without the need for a clinician. Further, a need is felt in the art for an adhesive product easily manipulatable by a patient according to their pain threshold. Accordingly, the presently disclosed subject matter provides an adhesive device that is quick to apply and easily operated by the patients themselves according to their respective pain thresholds.

The patch 102 described herein includes a two-piece assembly including a handle 104 and a base 106. The base 106 can include an adhesive known to have complementary reactivity to mammalian skin. The patch 102 can be employed to adhere to scar tissue or surrounding tissue. Once adhered to scar tissue, the patch 102 may be manipulated to exert a force to soften or break up scar tissue beneath, near, and/or around the patch 102. Further, the patch 102 may be quickly and easily applied and operated without the need for a clinician to be present, thereby allowing a patient to simply and efficiently manipulate scar tissue. The patient may then easily, frequently, and substantially painlessly deliver a self-manipulation of the scar tissue, thereby promoting more regular scar manipulation for faster recovery and limiting the negative long-term effects caused by scar formation. Further, the patient may mobilize the scar tissue more frequently than in conventional methods by manipulating the patch 102 through various directions, thereby increasing the frequency of therapeutic tissue manipulation, reducing the negative scar effects, and aiding in a faster recovery.

Embodiments of the presently disclosed adhesive therapeutic device will now be described in detail with reference to the drawing figures. As used herein, the term “patient” should be understood as referring to a human subject or other animal, and the term “clinician” should be understood as referring to a doctor, nurse or other care provider and may include support personnel.

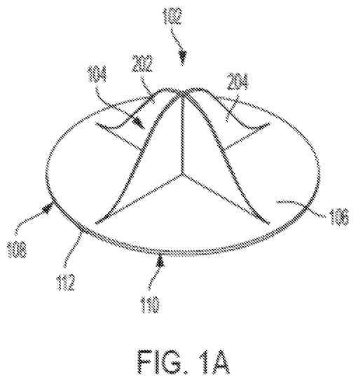

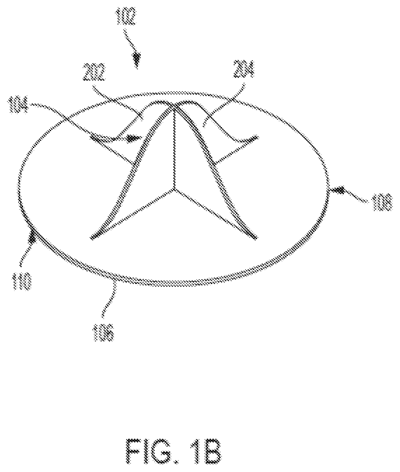

Referring now to FIGS. 1A-1B, there is illustrated a patch 102.

The patch 102 can include a handle 104 and a base 106. The patch can also be referred to as a therapeutic device, an adhesive pad, adhesive tab, mobilization device, scar manipulation device, tissue manipulator, myofascial release patch, or a physical therapy tab. The handle 104 can be adapted for grasping and manipulating patch 102. The handle 104 can be in communication with the base 106 such that movement of the handle 104 can cause a corresponding movement of the base 106. The handle 104 can be configured to be moveable via manual manipulation, for example, moveable via the manual manipulation in x, y, and z directions.

The x and y directions can correspond to directions along the exterior surface of the user and the z direction can correspond to the direction orthogonal to the exterior surface of the user. The handle 104 can be movable via manual manipulation such that an exterior surface 704 of the user can moved, manipulated, twisted, pushed, and/or pulled from an initial starting position corresponding to where the patch 102 is placed on the user. The manual manipulation of the handle 104 can cause the exterior surface 704 to move relative to, pull away from, and/or push into the underlying tissue 702 disposed beneath the exterior surface 704.

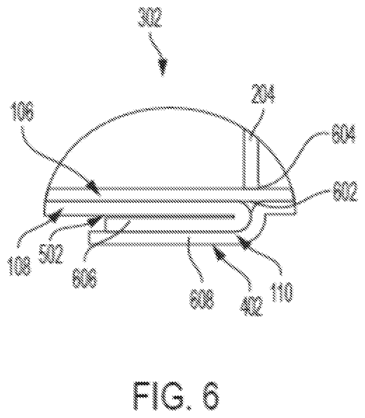

The patch 102 can include a first cover 108 interlocking with a second cover 110. The first cover 108 and second cover 110 can each have a first flap 606 and second flap 608, respectively, allowing for easy release (shown below in FIG. 6) from the patch 102. When the first cover 108 and second cover 110 are in the interlocked state, the first flap 606 and second flap 608 form a fold engagement section 112. The first and second covers 108, 110 can provide a protective cover such that a user engaging surface 602 of the base 106 does not adhere to another surface until the user is ready to apply the patch 102 to a tissue surface of the user's body.

The base 106 may be flexible or rigid depending upon the types of tissue to be approximated and covered. The base 106 can be configured to define a circular cross section. For example, the base 106 may be configured as a disk. While illustrated as a circular cross section, it is also contemplated that the base 106 may be of varying shapes and sizes depending on such factors as the location and size of the wound or scar tissue and the degree of rigidity that may be required of the patch 102.

In an embodiment, base 106 and/or handle 104 may be composed of a non-woven polyester, for example, spunbond polypropylene. Base 106 may also be formed of a material that is hypoallergenic. It is also envisioned that base 106 may be composed of materials that give base 106 a variety of characteristics, such as waterproof and/or semipermeable. As illustrated in FIGS. 1A and 1B, the base 106 is formed in a circular shape to improve adhesion to scar tissue. However, the base 106 can be formed as other shapes, such as elliptical, square, rectangular, oblong, and various other shapes to improve adhesion to scar or surrounding tissue.

Base 106 may have a variety of other characteristics. For example, the weight of the base 106 may range from 23 to 27 grams per square meter (GSM). In an embodiment, the weight of the base 106 may be 25 GSM. The machine direction (MD) of the base 106 can range from 49.5 to 72.5 (N/5 CM) with an MD tensile elongation percentage ranging from 35 to 105. In an embodiment, the MD of the base 106 can be 61.0 (N/5 cm) and the MD tensile elongation percentage can be 70%. Likewise, the cross-machine direction (CD) of the base 106 can range from 24 to 41 (N/5 CM) with a CD tensile elongation percentage ranging from 40.5 to 93.5. In an embodiment, the CD of the base 106 can be 33.0 (N/5 cm) and the CD tensile elongation percentage can be 67%. Air permeability of the base 106 as measured by a TEXTEST Air Permeability Tester using a 20 CM test head and 200 Pa of pressure can range from 160-240 (M3/M2/MIN.). In an embodiment, the TEXTEST air permeability of the base 106 can be 200 (M3/M2/MIN).

The handle 104 and base 106 may be integrally attached to each other, unitarily formed, monolithically formed, or any combination thereof. The handle 104 and base 106 may be separate pieces which may be attached by various methods, for example by an adhesive or mechanical attachment, and as would be readily envisioned by those skilled in the art, so that a variety of handle 104 and base 106 engaging portion configurations may be utilized. Further, the size and length of the handle 104 may vary depending on the scar tissue and the patch 102.

The handle 104 and the base 106 may be constructed by various techniques known in the art. For example, conventional injection molding may be used to form the handle 104, base 106, or combination thereof. Molten plastic could be injected in a shot into a molding cavity for the handle 104, base 106, or combination thereof. The molten plastic could be forced at high pressure and high velocity to run along sprue bushings/runners into the one or more cavities of the injection mold. These molding cavities of the injection mold could be defined between an injector mold plate and a closely contacting opposite ejector mold plate that together delimit one or more molding cavities and confine the injected volume of melted plastic. The injection mold with its molding cavities could be kept at a temperature below the solidification temperature of the plastic material injected. Pressure could then be maintained until the sprue at the injection gate solidifies so that no more material can enter the one or more cavities.

Solidification could in some applications be assisted by cooling lines in the mold. A cooling medium, such as water or oil, could then circulate within the cooling lines to achieve appropriate cooling. In such embodiments the mold could be kept cold during shot injection so that solidification of the molten plastic feedstock material starts almost instantaneously at the beginning of filling the one or more molding cavities. Once the desired cooling temperature has been reached, the mold could open and ejector pins ejects/eject the handle 104, base 106, or combination thereof from the injection mold.

As illustrated in FIG. 1B, the patch 102 can be configured so that the fold engagement section 112 below the patch 102 is not visible from various angles. For example, the flaps of the first cover 108, and a second cover 110 can be configured to intersect so that the fold engagement section 112 is not visible from a rear isometric view of the patch 102.

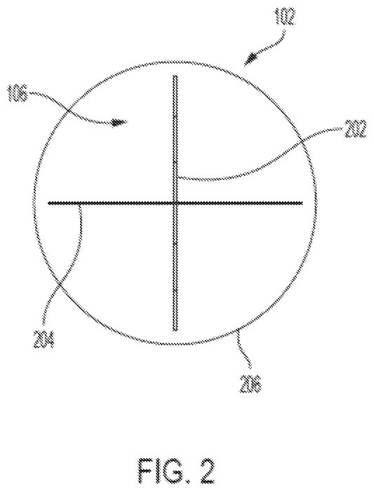

FIG. 2 shows an embodiment of the presently disclosed subject matter. As shown, the patch 102 is shaped as a circle or disk bounded by a circumference 206. The handle 104 is formed of first handle member 202 and second handle member 204, for example, each disposed at right angles relative to their cross sections. It is contemplated that each of the first handle member 202 and second handle member 204 may be formed as a half circle affixed to the other at a central axis, thereby forming an “X” configuration.

The first handle member 202 and second handle member 204 may be integrally attached to each other, unitarily formed, or any combination thereof.

In some embodiments, circumference 206 can range from 2.00 in to 5.00 in in length. In other embodiments, the circumference 206 can be 2.00 in, 3.00 in, 4.00 in, or 5.00 in. Similarly, the first handle member 202 and second handle member 204 can range from 1.50 in to 4.5 in in length. Both the first handle member 202 and second handle member 204 can be 1.50 in, 2.50 in, 3.50 in, or 4.50 in in length, for example, with the distal edge (in this case the edge furthest from the center of the patch 102) of each grip displaced approximately 0.25 in inward from the circumference 206.

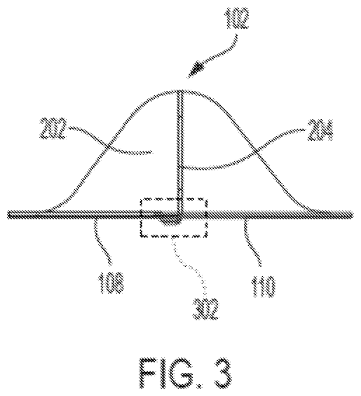

As shown in FIG. 3, the first handle member 202 may be defined as a cross section having a linear bottom that is configured for attachment to the base and having an arcuate top that extends furthest from the opposite surface of the base. Likewise, the second handle member 204 may also be formed as a cross section having a linear bottom that is configured for attachment to the base and having an arcuate top that extends furthest from the opposite surface of the base. In an embodiment, each of the first handle member 202 and second handle member 204 may define a sinusoidal cross section. The height of the first handle member 202 and second handle member 204 at the apex of the vertical axis can range from 0.60 in to 1.8 in. In some embodiments, the first handle member 202 and second handle member 204 can be 0.60 in, 1.0 in, 1.4 in, or 1.8 in in height.

A cover engagement section 302 is located substantially on the vertical axis formed by the intersection of the first handle member 202 and second handle member 204. The cover engagement section 302 is located below the intersection of the first handle member 202 and second handle member 204 and is further detailed in FIG. 6.

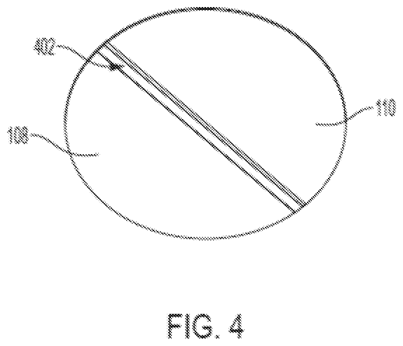

FIG. 4 shows an embodiment where the first cover 108 and second cover 110 are in an engaged state forming a mated combination. A male flange 402 extending from the second cover 110 mates with a corresponding female flange to interlock the first cover 108 and second cover 110 together. The fold engagement section 112 can provide the requisite friction to maintain the covers 108, 110 in the interlocked state.

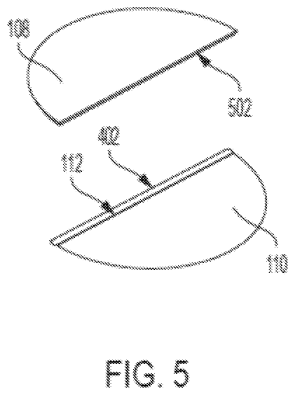

FIG. 5 similarly shows an embodiment with the covers 108, 110 in a disengaged state. The male flange 402 is not in contact with the female flange 502 of the first cover 108. The disengaged state can occur, for example, when a user pulls either the first flap 606 or second flap 608, thereby removing the first cover 108 and second cover 110.

Shown in FIG. 6 is a detailed view of the cover engagement section 302 of the base 106. The base 106 includes a user engaging surface 602 and an opposite surface 604. The user engaging surface 602 can face the user tissue. Directly opposite, the opposite surface 604 can face away from the user tissue. The user engaging surface 602 can be used to contact the tissue of the user. The opposite surface 604 is adapted for connection to handle 104 of patch 102. The handle 104, for example, can be orientated to that the handle 104 projects away from the base 106 in a direction away from the user engaging surface 602.

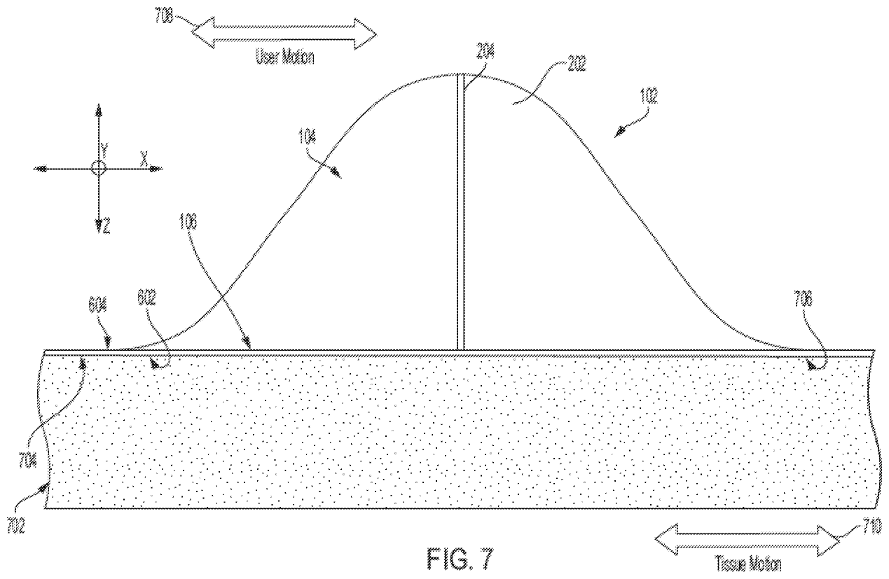

The user engaging surface 602 may be formed as an absorbent pad, surgical dressing, or wound dressing. Further, user engaging surface 602 can be composition of elements. For example, the user engaging surface 602 can be a wound dressing where an additional adhesive layer is included on the wound facing side of the absorbent layer to form the wound contacting surface. The user engaging surface 602 includes an adhesive 706 (shown below in FIG. 7) to affix to the tissue of the user.

The user engaging surface 602 may form a bond with the first cover 108 and second cover 110, for example by a suitable reactive component, thereby covering and protecting the adhesive 706. Reactive components may include crosslinkers, adhesives, sealants, couplers, and the like that are capable of bonding with at least one reactive group capable of bonding the user engaging surface 602 with the first cover 108 and second cover 110, so that the user engaging surface 602 is covered.

The first cover 108 and second cover 110 may be configured to form the fold engagement section 112. For example, first flap 606 of the first cover 108 may be folded laterally to overlay itself forming a first fold and second flap 608 of the second cover 110 may then be overlayed on the first fold to form a second fold. The surfaces of the first flap 606 and second flap 608 may be coated with a reactive layer as described herein to affix the flaps in place. The areas of contact between the first flap 606 and second flap 608 may lack substantial adhesive qualities so that a clinician may easily open the fold engagement section 112, and thus disengage the first covers 108 and second cover 110 from the user engaging surface 602.

Shown in FIG. 7 is a cross-sectional view of the patch 102 attached to the exterior surface 704 of the user and the cover engagement section 302. An adhesive 706 is attached to the engaging surface 602. The adhesive 706 is configured to form a sufficiently strong bond with the user's exterior surface 704 such that movement of the base 106 causes movement of the tissue 702 beneath the user's exterior surface 704. The bond provided is sufficient to provide for the myofascial release when the handle 104 causes the base 106 to move.

The adhesive 706 may include reactive groups for fixation on the exterior surface 704, for example, by crosslinking with reactive groups present in the tissue. The crosslinking may be accomplished by any of a number of mechanisms, including chemical (e.g., covalent) or physical (non-covalent) polymerization, complexation, hydrogen bonding, biological linking, combinations thereof, and the like.

The reactive groups may be positioned on the adhesive 706 by various methods for positioning known in the art. For example, the adhesive 706 may be formed from materials which naturally position reactive groups toward the outer surface of the adhesive 706. Methods for coating the adhesive 706 are within the purview of those skilled in the art, and include but are not limited to spraying, dipping, brushing, vapor deposition, co-extrusion, capillary wicking, film casting, molding, and the like. The reactive groups may be combined with the adhesive 706 in the form of a coating, film, foam, or powder on at least a portion of the tissue reactive, or combination thereof.

In an exemplary method of using the patch 102, to apply the patch 102, a user (e.g., a patient or clinician) can first remove the covers 108, 110 by manipulation of the flaps 606, 608 such as by pulling or tugging. The base 106 of the patch can thereby be exposed. By using, grasping, pinching, and/or manipulating the handle 104, the user can move the patch 102 toward the exterior surface 704. The user can affix the base 106 to the exterior surface 704. The adhesive 706 affixed to the base 106 can bond the patch 102 to the exterior surface 704.

After the base 106 is sufficiently bound to the exterior surface 704 of the user, via manual manipulation the user may create a user motion 708 by moving the handle 104 of the patch 102 in x, y, and/or z directions. The user motion 708 can be transmitted to the exterior surface 704 and inward to the tissue 702 disposed beneath, thereby creating a complimentary tissue motion 710. The tissue motion 710 can mobilize any scar tissue disposed within the tissue 702 (e.g., by stretching the deeper layers under and around the scar) and can cause myofascial release while also improving the active and passive range of motion, circulation of arterial and venous supply, nerve conduction, and lymph flow.

When a user is finished using the patch 102, the user can leave the patch 102 on the exterior surface 704 and the patch 102 can become detached after a period of time when the adhesive 706 no longer maintains sufficient strength to stay attached to the exterior surface 704. If the user desires to leave the patch 102 on the exterior tissue, the user can use the patch 102 to mobilize scar tissue numerous times until the adhesive 706 no longer maintains sufficient strength to stay attached to the exterior surface 706. Alternatively, the user can peel the patch 102 off of the exterior surface 704 when the user desires.

As shown in FIG. 7, the user motion 708 can be along the x-direction and can cause tissue motion 710 along the x-direction. However, user motion 708 can also be along the y-direction, the z-direction, along non-linear motion paths such as twisting motions, pulling motions, pressing motions, and any combination thereof. The tissue motion 710 can also be in the y-direction, the z-direction, along non-linear motion paths such as twisting motions, pulling motions, pressing motions, and any combination thereof.

Embodiments are intended to include or otherwise cover various methods of using and methods of manufacturing the patch 102 disclosed above. For example, the user motion 708 can include numerous movements of the patch 102 after a user has applied it to the exterior surface 704 (which could be above or on a scar, for example). The user can grasp or pinch the handle 104 and move the patch 102 along the length of the scar, perpendicular to the scar, and/or in various directions other directions relative to the length of the scar. Additionally, the user can pull the patch 102 away from the exterior surface 704 using the handle 104. Because the patch 102 is attached or bonded to the skin on the exterior surface 704, the skin can lift up from the underlying tissue 702. This can loosen up various tissue layers underneath the exterior surface 704 including scar tissue that may have formed in various layers of tissue of the user.

The lifting up of the patch 102 attached to the exterior surface 704 can also lift up additional layers of tissue beneath the skin. The user can push the patch 102 toward the exterior surface 704 to manipulate the tissue 702 in another direction.

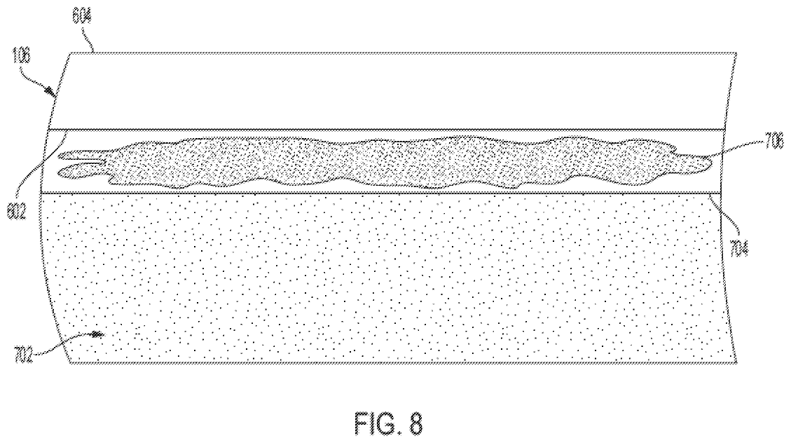

FIG. 8 shows another cross-sectional view of the patch 102 applied to the exterior surface 704 of the user as shown in FIG. 7. The user engaging surface 602 can include the adhesive 706 that is in communication with the exterior surface 704 of the user. The adhesive 706 can allow nonpermanent attachment of the patch 102 to the user so as to allow for mobilization of the tissue 702 disposed beneath the exterior surface 704. In the embodiment shown in FIG. 8, the adhesive 706 can appear to be between the exterior surface 704 and the user engaging surface 602. However, in other embodiments the adhesive can be incorporated into or as part of the user engaging surface 602 of the base 106. For example, the user engaging surface 602 may include adhesive-like qualities and/or materials sufficient to attach to the exterior surface 704 without the need for additional adhesive. In other embodiments, the user engaging surface 602 may attach to the exterior surface 704 of the user with suction forces, grips, restraints, and various other attachment mechanisms as may be desired.

The patch 102 may be used in a medical/rehabilitative capacity after knee replacement surgery. However, it is also envisioned that the patch can be used in a variety of medical procedures, but not limited to after orthopedic surgeries, heart surgery, abdominal surgery, C-section procedures, burn treatments, cosmetic surgery, and large bruising from trauma, etc.

While certain embodiments of the invention are described above, it should be understood that the presently disclosed subject matter can be embodied and configured in many different ways without departing from the spirit and scope of the invention.

For example, embodiments are disclosed above in the context of a patch 102 having a substantially circular shape including a circumference 206 with first handle member 202 and second handle member 204 forming a substantially perpendicular cross-section centered within the circumference. However, embodiments are intended to include or otherwise cover any type of arrangements of the first handle member 202 and the second handle member 204 on the circumference 206 of the base 106. For example, exemplary embodiments are intended to cover first and second handle members 204, 206 that are not centered within the circumference 206. Exemplary embodiments are intended to cover a patch 102 having a first handle member 202 that is a different size and/or shape than the second handle member 204.

Exemplary embodiments are intended to cover various dimensions of the patch 106. For example, exemplary embodiments can include the distal edge(s) of first and/or second handle members 202, 204 extending to the circumference 206. That is, each of the first and second handle members 204, 206 can extend on one end from one point of the circumference to the other end at another point on the circumference.

Exemplary embodiments of the patch 102 are intended to cover various shapes and sizes including, but not limited to, sizes sufficient to cover large areas of scar tissue on a user's legs, arms, back, torso, or any other appropriate location.

Exemplary embodiments are also intended to cover a handle 104 that includes material sufficient to improve a user's grip of the handle 104. For example, exemplary embodiments are intended to include or otherwise cover any type of grip feature added to the handle including but not limited to, non-slip material, protrusions, hoops, rings, pulls, or any type of member configured to facilitate movement of the patch 102 via the handle 106 in any direction relative to the base 106 and/or exterior surface 704 of the user.

Persons skilled in the art will understand that the devices and methods specifically described herein and illustrated in the accompanying figures are non-limiting exemplary embodiments, and that the description, disclosure, and figures should be construed merely exemplary of particular embodiments. It is to be understood, therefore, that the present disclosure is not limited to the precise embodiments described, and that various other changes and modifications may be affected by one skilled in the art without departing from the scope or spirit of the disclosure. Additionally, it is envisioned that the elements and features illustrated or described in connection with one exemplary embodiment may be combined with the elements and features of another without departing from the scope of the present disclosure, and that such modifications and variations are also intended to be included within the scope of the present disclosure. Accordingly, the subject matter of the present disclosure is not to be limited by what has been particularly shown and described, except as indicated by the appended claims.

What is claimed is:

1. A patch configured for nonpermanent attachment to an exterior surface of a user, wherein tissue is disposed beneath the exterior surface, the patch comprising:
a base defining opposing substantially planar surfaces, the substantially planar surfaces including a user engaging surface and an opposite surface, the user engaging surface including an adhesive configured for non-permanent attachment to the user's exterior surface, the adhesive being configured to form a sufficiently strong bond with the user's exterior surface such that movement of the base causes movement of the tissue beneath the user's exterior surface; and
a handle projecting from the opposite surface of the base in a direction away from the user engaging surface, the handle communicating with the base such that movement of the handle causes movement of the base.

2. The patch of claim 1, wherein the sufficiently strong bond provided by the adhesive is sufficient to provide myofascial release if the handle moves to cause the base to move.

3. The patch of claim 1, wherein the base is configured to define a circular cross section.

4. The patch of claim 1, further including a cover that is configured to cover at least a portion of the engaging surface of the base that includes the adhesive.

5. The patch of claim 4, further including a second cover that is configured such that the cover and the second cover together cover the engaging surface.

6. The patch of claim 1, wherein the handle includes a first handle member that defines in cross section a linear bottom that is configured for attachment to the base, the first handle member also defining in cross section an arcuate top that extends furthest from the opposite surface of the base.

7. The patch of claim 6, wherein the handle further includes a second handle member that defines in cross section a linear bottom that is configured for attachment to the base, the second handle member also defining in cross section an arcuate top that extends furthest from the opposite surface of the base.

8. The patch of claim 7, wherein each of the first and second handle members define a sinusoidal cross section.

9. The patch of claim 7, wherein the first and second handle members are integrally attached to each other.

10. The patch of claim 9, wherein the first and second handle members are disposed at right angles relative to their cross sections.

11. The patch of claim 7, wherein the first and second handle members are unitarily formed.

12. The patch of claim 1, wherein at least one of the base and the handle are formed of non-woven polyester.

13. The patch of claim 12, wherein both the base and the handle are formed of non-woven polyester.

14. The patch of claim 1, wherein the base and the handle are formed unitarily.

15. The patch of claim 1, wherein the base and the handle are attached via adhesive.

16. The patch of claim 1, wherein the base and the handle are attached via mechanical attachment.

17. The patch of claim 1, wherein the handle is configured such that the handle is moveable via manual manipulation.

18. The patch of claim 17, wherein the handle is moveable via the manual manipulation in at least the direction along the exterior surface of the user and along the direction orthogonal to the exterior surface of the user.

19. The patch of claim 1, wherein at least the base is formed of material that is hypoallergenic.

20. The patch of claim 1, wherein the base is formed of material that is at least one of waterproof and semipermeable.
